(19) United States
(12) Patent Application Publication
(10) Pub. No.: US 2017/0136416 A1
(43) Pub. Date: May 18, 2017

(54) FILTRATION DEVICE

(71) Applicant: Sartorius Stedim Biotech GmbH, Goettingen (DE)

(72) Inventor: Martin Leuthold, Goettingen (DE)

(21) Appl. No.: 15/129,440

(22) PCT Filed: Apr. 1, 2015
(86) PCT No.: PCT/EP2015/057237

§ 371 Date: Sep. 27, 2016

(30) Foreign Application Priority Data
Apr. 8, 2014 (DE) 10 2014 104 984.5

(51) Int. Cl. B01D 65/00; B01D 63/10; B01D 63/08

(52) U.S. Cl. CPC B01D 65/003; B01D 63/082; B01D 63/10

(57) ABSTRACT

A filtration device (1, 1′) has a housing (2, 2′) with an inlet (3, 3′) to supply fluid to be filtered and an outlet (4, 4′) to discharge filtered permeate. A filter module (5, 5′) is between the inlet and outlet and has membrane layers (9, 9′) connected to the housing (2, 2′) in a fluid-tight manner. An inflow channel (11, 11′) is at the inlet side (3, 3′) and an outflow channel (12, 12′) is at the outlet side (4, 4′). A compressible and flow-permeable intermediate layer (10, 10′) is arranged between at least two membrane layers (9, 9′). The intermediate layer (10, 10′) is made of a nonwoven material with: a thickness corresponding to 20 to 200% of the thickness of the membrane layers (9, 9′), a basis weight of 10 to 150 g/m², and an air flow rate therethrough of 150 to 5000 L/(m² * s).

### BACKGROUND

1. Field of the Invention

The invention relates to a filtration device comprising a housing with an inlet to supply fluids to be filtered and an outlet to discharge filtered permeate, as well as a filter module arranged between the inlet and outlet and having a plurality of membrane layers comprising at least one membrane, the membrane layers being attached to the housing in a fluid-tight manner, wherein, relative to the filter module, an inflow channel is arranged upstream at the inlet side and an outflow channel is arranged downstream at the outlet side.

2. Description of the Related Art

Membrane adsorbers (porous adsorption membranes) are an established alternative to conventional chromatographic gels (definition: polymerization and polycondensation resins, cross-linked polyacrylamide or polydextran gels, cellulose). In contrast to gels, the adsorptive material is not packed into columns, but rather preferably designed in the form of flat filters or spiral-wound modules structurally comparable to filter capsules. The use of multiple layers results in a chromatographically active layer (bed), comparable to gel chromatography, with a defined height.

The chromatographic performance of such a filter module depends fundamentally not only on the characteristics of the adsorptive medium used (e.g. flow performance, binding capacity), but also on the design of the filter module as such. A disadvantageous design of the channels due, for example, to over- or under-dimensioned cross-sections, large dead volumes or dead zones, has a negative impact on the performance. Performance here relates in particular to breakthrough behavior, pressure loss across the chromatographic bed, options for deaeration or separation efficiency, as well as the use of buffers for the various chromatographic steps. One of the most important factors affecting the design of filtration units is fluid dynamics. This has a major influence on back-mixing effects as well as on promoting even inflow and outflow relative to the chromatographic bed.

Optimized spiral-wound modules or flat filter modules generally are adapted, in terms of their flow performance, to the geometries of the flow channels, with the intention of avoiding potential dead zones, i.e., the aim is to reduce the dead volume. The dead volume can be described as the ratio of the dead volume to the bed volume, with the bed volume being derived from the thickness of the membrane and the installed membrane area.

DE 19711083 C2 and DE 19711186 A1 each disclose a filtration device comprising a housing with an inlet to supply fluid to be filtered and an outlet to discharge filtered permeate, as well as a filter module, which can be designed as a membrane adsorber module, arranged between the inlet and outlet. In this case, the adsorber module is designed as an adsorption membrane wound up into a hollow cylinder. The membrane adsorber module has an inner annular gap oriented toward the core and an outer annular gap oriented toward the wall of the membrane adsorber capsule, the outer annular gap forming an outflow channel and the inner annular gap forming an inflow channel. On each of the end surfaces, the membrane adsorber module is sealed with a casting compound. A medium can be supplied through the inner annular gap and can be channeled in a radial direction through the wall of the membrane adsorber module, while the permeate can be drained away through the outer annular gap. The adsorber or filter module can also be designed as a flat filter module with stacked flat membrane layers.

It is known that functionalized membranes can swell, i.e. their thickness can increase. In a multi-layer design therefore, even apparently only minor swelling can affect the overall performance of the filtration unit. This applies in particular to filtration units with optimized, and therefore correspondingly small, channel cross-sections. Swelling can cause the channel cross-sections to become narrower and can increase the packing density of the chromatographic bed. This results in a decreased flow rate as well as poorer flow distribution, thereby reducing chromatographic performance (increase in the breakthrough curve, width of the elution peak, buffer consumption).

In addition to the general compression of the membrane stack caused by the application of a pressure gradient between the inlet and outlet, compression increases as described above due to the swelling behavior of the membrane. This results in compaction of the membrane stack. Furthermore, it can lead to narrowing of the inlet and/or outlet channel. These effects thus cause uneven distribution with regard to flow through the membrane stack as well as increased pressure loss, thereby resulting in the disadvantages described. The effect becomes more pronounced as the number of membrane layers increases.

DE 100 22 259 A1 discloses the arrangement of a retentate spacer element between two membrane layers of cross-flow filter cassettes to form overflow gaps, the edge areas of which spacer element are covered by retentate spacer frames on both sides. The retentate spacer element, which forms an intermediate layer not directly adjacent to the membrane layers, consists of an open-mesh fabric matrix that is not compressible in relation to the membrane layers.

In the event of swelling of the membrane layers, the use of compressible intermediate layers as retentate spacer elements can, for example, result in narrowing of the overflow gaps, thereby reducing performance.

U.S. Pat. No. 3,508,662 A discloses a spiral-wound module for an artificial kidney that has a membrane layer with a supporting mesh of nonwoven plastic as an intermediate layer. The intermediate layer forms a spacer in the form of a supporting mesh made of a plastic, such as polyolefin, e.g., polypropylene. The membrane layer with the intermediate layer is wound spirally around an inner core.

Nothing can be taken from U.S. Pat. No. 3,508,662 A regarding the relevant physical properties of the intermediate layer in relation to the membrane layer with regard to compressibility and throughflow.

The problem that the present invention seeks to solve is to improve known filter devices, especially those with optimized functionalized filter modules, so as to avoid the disadvantages that can result from swelling of the membranes and also to make the filter apparatuses simple and cost-effective to design and manufacture.

### SUMMARY

This problem is solved in with a filtration device that has a housing with an inlet to supply fluid to be filtered and an outlet to discharge filtered permeate. A filter module is arranged between the inlet and the outlet and has a plurality of membrane layers connected to the housing in a fluid-tight manner. Relative to the filter module, an inflow channel is arranged upstream at the inlet side and an outflow channel is arranged downstream at the outlet side. The filtration device is further characterized by a compressible and flow-permeable intermediate layer is arranged between at least two membrane layers. The intermediate layer is made of a nonwoven material. The thickness of the intermediate layer corresponds to 20 to 200% of the thickness of the membrane layers, the basis weight of the intermediate layer is 10 to 150 g/m² and the air flow rate through the intermediate layer is 150 to 5000 L/(m²*s)

The arrangement of a compressible and flow-permeable intermediate layer between at least two membrane layers compensates for the swelling of the membrane layers and avoids performance loss of the filtration apparatus. Since various buffers and their components have significantly different effects on swelling, the use of compressible intermediate layers furthermore has the effect of making pressure loss less dependent on the buffer, which, for example, also makes loading with distilled water possible with low pressure loss.

Moreover through the use of intermediate layers, more homogenous flow can be achieved through areas of individual membrane layers through which flow rate differs (e.g., due to pore size distribution, degree of grafting). The medium can therefore distribute itself relatively homogenously in the individual intermediate layers.

Nonwovens are highly suitable due to their mechanical properties, such as compressibility and much lower flow resistance compared to membranes. “Nonwoven” refers generally to all materials which are made of fibers and manufactured according to DIN 61210 (dry nonwovens, wet nonwovens, nonwovens produced using the extrusion process, etc.). Alternatively other intermediate layers can also be used, such as fabrics or other porous solid bodies. It is therefore also possible to employ intermediate layers with different properties (e.g., thickness, basis weight). Fibers made of plastics, such as polyakylenes, polypropylene (PP), polyethylene (PE), polystyrene (PS), polyurethane (PU), polysulfones, polyethersulfones or polyester are especially suitable.

In one embodiment of the invention, the thickness of the intermediate layer corresponds to 75 to 125% of the thickness of the membrane layers, the basis weight of the intermediate layer is 30 to 80 g/m² and the air flow rate through the intermediate layer is 2000 to 5000 L/(m²*s).

The nonwoven material of the intermediate may be made of a synthetic polymer.

The ratio of dead volume to filter material volume may be in the range of 1.2 to 1.6 at a filter material porosity of 80% which is self-regulating through the intermediate layers.

The compressible intermediate layer may have a lower flow resistance than the membrane layers.

In one embodiment of the invention, the intermediate layer has a predetermined structure.

The compensation for membrane layer swelling may be supported not only by the compressibility of the intermediate layer, but also by the structure of the intermediate layer, for example, cavities on the surface.

The thickness of the intermediate layer may be predetermined depending on the degree of swelling of the membrane layers and on the physical properties of the intermediate layer.

The preferred thickness of the intermediate layer may be determined according to the degree of swelling of the membrane as well as the physical properties of the intermediate layers (e.g. compressibility, surface structure). For nonwovens (e.g. synthetic polymers; specially extruded spunbond nonwovens) as intermediate layers, the following defining parameters can be used; the relevant physical properties can be described through the combination of basis weight, thickness and air flow rate:
Thickness of 20-200% of the thickness of the membrane layer, for example, for Sartobind® membrane adsorbers produced by the firm Sartorius Biotech GmbH approx. 50-400 μm.
75-125% of the thickness of the membrane layer is especially preferred, for example for Sartobind® membrane adsorbers from Sartorius Biotech GmbH approx. 200-330 μm.
Basis weight of 10 to 150 g/m², the range of 30 to 80 g/m² being especially preferred, and the ratio of thickness [μm] to basis weight [g/m²] being ideally between 3 and 7.
Air flow rate of 150 to 5000 L/(m²*s), the range 2000-5000 L/(m²*s) being especially preferred (air flow rate is usually given in this form for nonwovens). The value for technical nonwovens is measured at a differential pressure of 2 mbar (DIN EN ISO 9237).

Generally, thicknesses of between 0.1 and 0.3 mm have been shown to be advantageous for the intermediate layers.

The inflow channel and/or the outflow channel also may have a compressible and flow-permeable intermediate layer.

The outflow channel can also have a relatively rigid intermediate layer made of fabric to prevent narrowing of the channel cross-section due to the existing pressure gradient across the filter module.

The filter module may be designed as a flat filter module with stacked flat membrane layers. The filter module can, however, also be designed as a spiral-wound module with a web wound around a core. The web may be made of at least one membrane layer and in a particular embodiment of the invention, the intermediate layer is arranged as a web in sections between the at least one membrane layer.

The membrane layers may be adsorption filters. In particular, the filtration device can be used for chromatographic separation of molecules by means of membrane adsorbers. The membrane layers of the adsorption filter can be equipped with the same or different adsorption properties.

The filtration device may be a sterile connectable component for pre-sterilized units having at least one flexible container.

Further features of the invention can be obtained from the following detailed description and from the attached drawings, in which examples of preferred embodiments of the invention are depicted.

### BRIEF DESCRIPTION OF THE DRAWINGS

FIG. 1 a lateral cross-sectional view of a filtration device with a filter module designed as a flat filter module.

FIG. 2 a lateral cross-sectional view of a filtration device with a filter module designed as a spiral-wound module.

FIG. 3 a lateral cross-sectional view of the filtration device from FIG. 1 with throughflow illustrated schematically by means of arrows.

FIG. 4 a lateral cross-sectional view of the filtration device from FIG. 2 with throughflow illustrated schematically by means of arrows.

### DETAILED DESCRIPTION

A filtration device 1 essentially comprising a housing 2, an inlet 3, an outlet 4 and a filter module 5.

At the top, in the vertical direction, the housing 2 has the inlet 3 in the area of a lid 6 and, at the bottom in the vertical direction, it has the outlet 4 in the area of a base 7. In the vertical direction at the top, the lateral housing wall 8 is sealed by the lid 6 and in the vertical direction at the bottom, it is sealed by the base 7.

The filter module 5 is arranged between the inlet 3 and the outlet 4 of the housing 2. The filter module 5 has a plurality of membrane layers 9 which are connected in a fluid-tight manner to the housing 2 in order to ensure that all of the fluid supplied through the inlet 3 must pass through the membrane layers 9 and cannot circumvent them without being filtered. In the exemplary embodiments, a flow-permeable and compressible intermediate layer 10 is arranged between each of the membrane layers 9. Relative to the membrane filter module 5, an inflow channel 11 is located upstream at the inlet side 3 and an outflow channel 12 is arranged downstream at the outlet side 4.

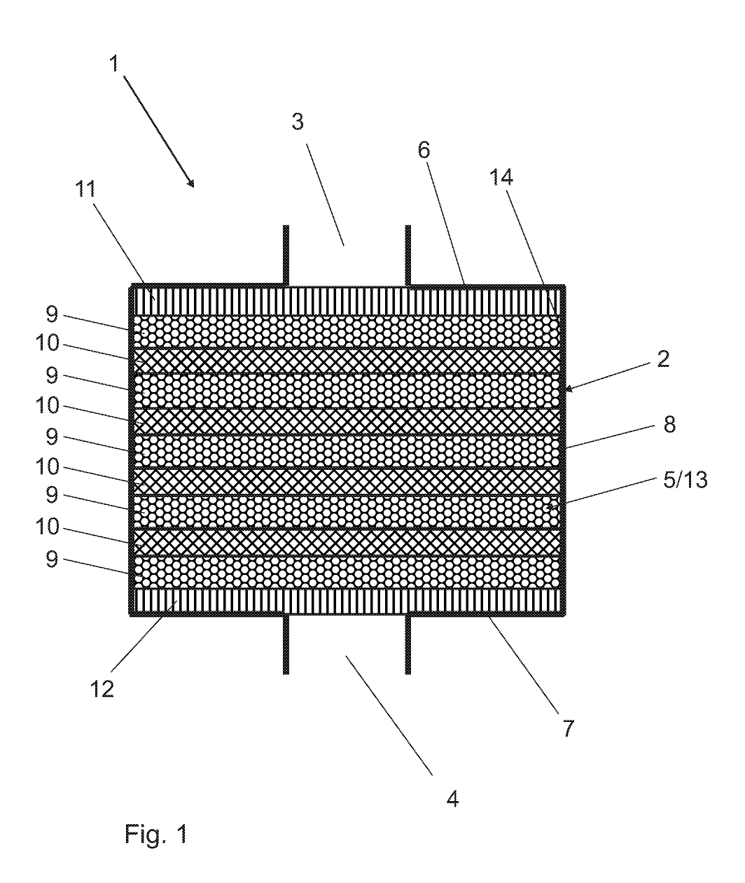

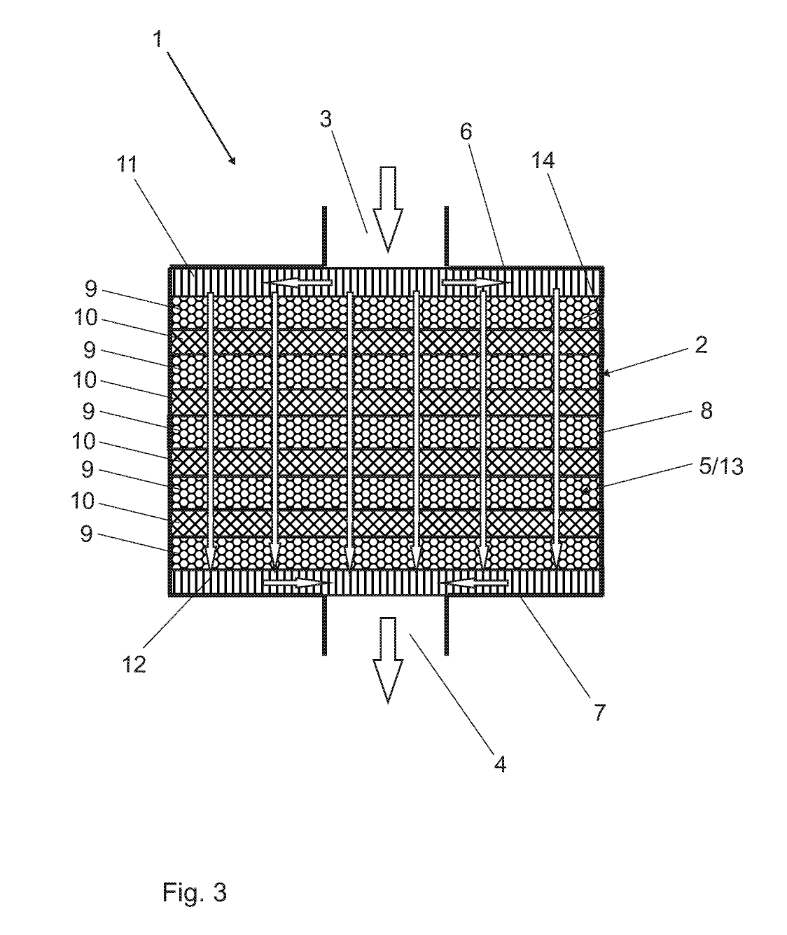

According to the exemplary embodiment in FIGS. 1 and 3, the filter module 5 is designed as a flat filter module 13 with stacked flat membrane layers 9. The intermediate layers 10 are arranged between the membrane layers 9. The flat membrane layers 9 are connected at their circumferential lateral surfaces 14 with the lateral housing wall 8 in a fluid-tight manner. The inflow channel 11 and the outflow channel 12 run parallel to the horizontally arranged membrane layers 9 and are therefore arranged perpendicular to the lateral housing wall 8. FIG. 3 shows an example of the flow distribution within the flat filter module 13.

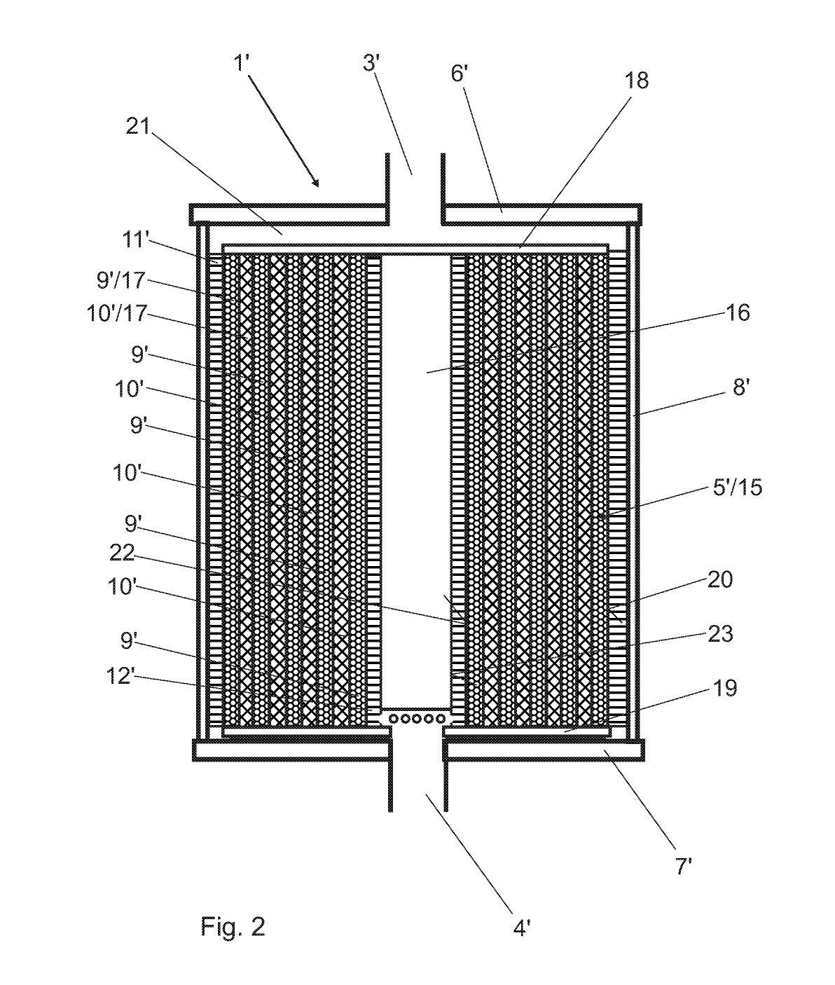

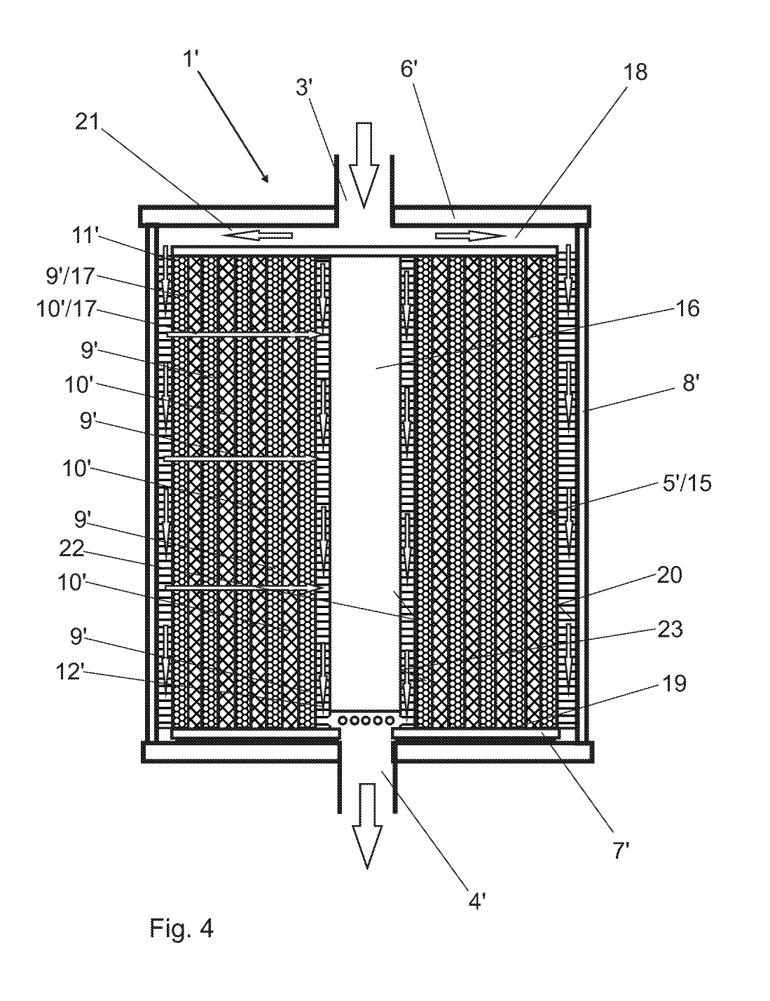

According to the exemplary embodiment in FIGS. 2 and 4, the filter module 5′ is designed as a spiral-wound module 15 with a web 17 wound onto a vertically arranged core 16. The web 17 consists of a web-shaped membrane layer 9′ and a web-shaped intermediate layer 10′. With reference to the cross-section, the winding also results in a plurality of membrane layers 9′ between which the intermediate layers 10′ are arranged. The spiral-wound module 15 is capped, in a fluid-tight manner, in the vertical direction at the top, by an upper end cap 18 and, in the vertical direction at the bottom, by a lower end cap 19. The lower end cap 19 is additionally connected in a fluid-tight manner to the base 7′ of the housing 2′.

The inflow channel 11′ is formed from an outer annular gap between the lateral housing wall 8′ and the vertical outer surface 20 of the spiral-wound module 15. The inflow channel 11′ is connected to the inlet 3′ via a horizontal channel space 21 formed between the upper end cap 18 and lid 6′.

The outflow channel 12′ is formed by an inner annular gap between the vertical inner surface 22 of the spiral-wound module 15 and the lateral outer wall 23 of the core 16. The outflow channel 12′ is connected to the outlet 4′ at the lower end of the core 16.

Of course, the embodiments discussed in the specific description and shown in the figures are merely illustrative exemplary embodiments of the present invention. In light of this disclosure, a person skilled in the art is given a wide range of possible variations.

### LIST OF REFERENCE NUMBERS

1, 1′ filtration device

2, 2′ housing

3, 3′ inlet

4, 4′ outlet

5, 5′ filter module

6 lid

7, T base

8, 8′ lateral housing wall

9, 9′ membrane layers

10, 10′ intermediate layer

11, 11′ inflow channel

12, 12′ outflow channel

13 flat filter module

14 lateral surface of 9′

15 spiral-wound module

16 core

17 web

18 upper end cap

19 lower end cap

20 vertical outer surface of 15

21 horizontal channel space

22 vertical inner surface of 15

23 lateral outer wall of 16

1. A filtration device (1, 1′) comprising:
a housing (2, 2′) with an inlet (3, 3′) to supply fluid to be filtered and an outlet (4, 4′) to discharge filtered permeate;
a filter module (5, 5′) arranged between the inlet (3, 3′) and the outlet (4, 4′) and having a plurality of membrane layers (9, 9′) including at least one membrane, the membrane layers (9, 9′) being connected to the housing (2, 2′) in a fluid-tight manner;
an inflow channel (11, 11′) arranged upstream of the membrane layers (9, 9′) and in proximity to the inlet (3, 3′);
an outflow channel (12, 12′) arranged downstream of the membrane layers (9, 9′) and in proximity to the outlet (4, 4′) and;
a compressible and flow-permeable intermediate layer (10, 10′) arranged between at least two of the membrane layers (9, 9′),
the intermediate layer (10, 10′) being made of a nonwoven material,
a thickness of the intermediate layer (10, 10′) corresponding to 20 to 200% of a thickness of the membrane layers (9, 9′),
a basis weight of the intermediate layer (10, 10′) is 10 to 150 g/m², and
an air flow rate through the intermediate layer (10, 10′) is 150 to 5000 L/(m²*s).

2. The filtration device of claim 1, wherein
the thickness of the intermediate layer (10, 10′) corresponds to 75 to 125% of the thickness of the membrane layers (9, 9′),
the basis weight of the intermediate layer (10, 10′) is 30 to 80 g/m², and the air flow rate through the intermediate layer (10, 10′) is 2000 to 5000 L/(m²*s).

3. The filtration device of claim 1, wherein
the nonwoven material of the intermediate layer (10, 10′) is made of a synthetic polymer.

4. The filtration device any of claim 1, wherein
the intermediate layer (10, 10′) has lower flow resistance than the membrane layers (9, 9′).

5. The filtration device of claim 1, wherein
the thickness of the intermediate layer (10, 10′) is predetermined depending on a degree of swelling of the membrane layers (9, 9′) and on physical properties of the intermediate layer (10, 10′).

6. The filtration device of claim 1, wherein
the inflow channel (11, 11′) and/or the outflow channel (12, 12′) has a compressible and flow-permeable intermediate layer (10, 10′).

7. The filtration device of claim 1, wherein
the filter module (5) is a flat filter module (13) with stacked flat membrane layers (9).

8. The filtration device of claim 1, wherein
the filter module (5′) is a spiral-wound module (15) with a web (17) of at least two membrane layers wound around a core (16).

9. The filtration device any of claim 1, wherein
the membrane layers (9, 9′) are adsorption filters with identical adsorption properties.

10. The filtration device of claim 1, wherein
the filtration device (1, 1′) is a sterile connectable component for pre-sterilized units with at least one flexible container.

11. (canceled)

12. The filtration device of claim 1, wherein
the membrane layers (9, 9′) are adsorption filters with different adsorption properties.
